(19) United States
(12) Patent Application Publication
(10) Pub. No.: US 2011/0010694 A1
(43) Pub. Date: Jan. 13, 2011

(54) Method for Creating Sub-Query Related Memory Stores

(75) Inventor: Matijs De Jong, Rotterdam (NL)

Correspondence Address: THE WEBB LAW FIRM, P.C., 700 KOPPERS BUILDING, 436 SEVENTH AVENUE, PITTSBURGH, PA, 15219, US

(73) Assignee: THRANX INVESTMENT B.V., Rotterdam (NL)

(21) Appl. No.: 12/812,206

(22) PCT Filed: Jan. 9, 2009
(86) PCT No.: PCT/NL09/00002

§ 371 Date: Sep. 29, 2010

(30) Foreign Application Priority Data
Jan. 9, 2008 (NL) 1034901

(51) Int. Cl. G06F 9/45

(52) U.S. Cl. 717/139

(57) ABSTRACT

The present invention relates to a method for creating a memory store for enabling a computer to interpret sub-query programming code in which code reuse is explicitly defined, the method comprising steps for defining data sources for first-order quantified queries, also known as sub-queries, in which method the main query data sources can be used as the sub-query data source for any repeated execution of code over collections of data and combinations of collections of data, such as tables, arrays and object collections. The method is preferably able to create a memory store for enabling a computer to interpret programming code in which first-order quantified queries, also known as sub-queries, can explicitly or implicitly reuse data sources defined for any repeated execution.

### FIELD OF THE INVENTION

The invention relates to the field of the development of programming, query and other computer languages for computers and other electronic devices.

### BACKGROUND

Computers and other electronic devices can be programmed to perform technical tasks or to perform tasks in a technical manner. This programming is done in a machine code specific to the machine in question. These machine codes, long lists of zeros and ones, are very difficult to understand and write. Computer scientists started developing programming languages to allow programmers to write instructions (source code) without knowing machine code. To create the machine code program needed by a specific computer the programmer uses another program, an interpreter, to translate the source code into machine code.

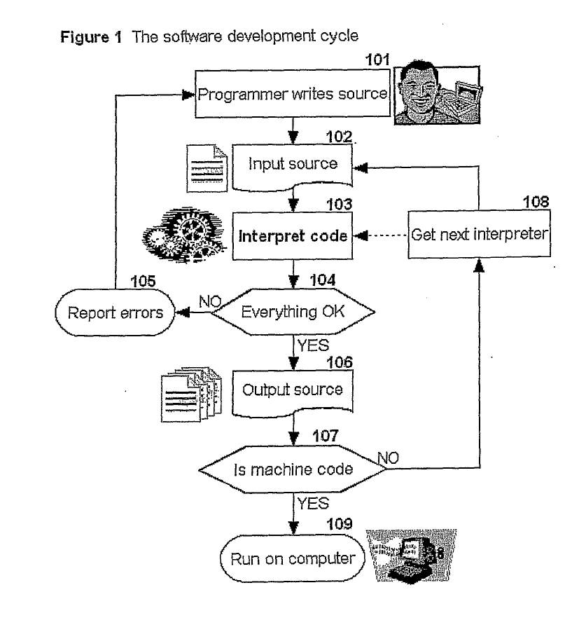

FIG. 1 shows a typical software development cycle. The programmer writes source code (101). The source code (102) is analyzed by an interpreter (103). When the interpreter finds an error (104) it does not generate any output code, but warns the programmer (105). The programmer then corrects the problem. If the source is interpreted correctly the interpreter generates new output code (106). The first interpreters generated machine code, but these days intermediate steps may be applied. The output source can be source in another language (107). This can be another human interpretable programming language, an intermediate language—e.g. Java byte code, not designed for human reading but for easy translation to the machine code of different machines—or machine code for a different machine than the target machine. In all these cases another interpreter is needed to translate the new output source (108). This cycle continues until the machine code is generated to run on the target machine (109).

The present invention solves a problem that allows for a computer to function in a technically optimized way relative to the state of the art of the above kind of interpreters (103) that allows for a programmer (101) to write code (102) that is less complicated and easier to understand to for man.

### SUMMARY OF THE INVENTION

In order to provide a solution in line with the above defined problem, the present invention provides for a method for creating a memory store for enabling a computer to interpret sub-query programming code in which code reuse is explicitly defined, the method comprising steps for defining data sources for first-order quantified queries, also known as sub-queries, in which method the main query data sources can be used as the sub-query data source for any repeated execution of code over collections of data and combinations of collections of data, such as tables, arrays and object collections.

An advantage of such a method according to the invention is that because the main query data can be reused as source for a sub-queries in case of repeated execution of code over collection of data almost natural sentences may be used for defining constructs of queries with sub-queries. This allows for much easier programming and therefore for more intricate programs or data queries at lower cost or while using programmers with lower skills for the job. While applying this invention it is much easier to provide for logical function in e.g. web shops allowing for better service to the clients. An example hereof is described below in which customers are indicated data about products that may be of interest to them. Applying the invention such functions may be defined in a more intricate manner at lower programming cost because the computer is able to use the definable memory store in the new way according to the invention.

The method is preferably able to create a memory store for enabling a computer to interpret programming code in which first-order quantified queries, also known as sub-queries, can explicitly or implicitly reuse data sources defined for any repeated execution.

In a first preferred embodiment, the method comprises steps for specifying a link between main query and sub-query using a single data item when the sub-query data source reuses the main query data source.

An advantage of this embodiment is that in certain examples merely one column needs to be specified for providing a link of a query to a sub query on e.g. the same column of a data source, such as a table.

A further preferred embodiment comprises steps for reusing the main query data source in sub-queries of the main query allowing for the sub queries to have no stated data source and/or for the sub query to use the memory store as data source. It is advantageous that the data source may be reused. Preferably, the main query data source is used in sub-queries of the main query allowing for new syntax keywords in sub-query statements.

By further preference, the method comprises steps for reusing syntax statements for filtering the main query data source for filtering the sub-query data source. This provides for the option of a further triggering of filter statements at the level of logical operators.

Advantageously, a further embodiment comprises steps for defining logical operators with scopes that enable them to filter, e.g. at the level of original operators, both the main query data source and the sub-query data source for other parts of the statements. In this embodiment it is enabled that new operators may be defined in a programming language that is new over the state of the art. This will be elucidated below.

A further improvement is embodied by a method further comprising steps for defining syntax statements that filter only the sub-query data source for other parts of the statements, which advantageously allows for only affecting the sub-query memory store.

Preferably steps are provided for providing a name for the current main query data source after queries have been added. This advantageously allows for a function that after a query is added to the store a name can be attached to the new state.

Another embodiment provides for comprised steps for naming the current main query data source after filters have been added. Preferably steps are comprised for for using named data sources as sub-query data source.

A further aspect of the invention provides a computer equipped for performing a method according to any of the above claims.

Further aspects of the invention provide:
A computer program product for when loaded on a computer system allowing the computer system to perform a method according to the invention;
A data carrier comprising a computer program product for enabling a computer to perform a method according to the invention;
A server computer comprising and/or equipped for distributing a computer program product for enabling a computer to perform a method according to the invention;
A method for electronically or optically distributing a computer program product for enabling a computer to perform a method according to the invention, the method comprising steps aimed at transfer of the computer program product.
A method for providing computer executing services by means of a computer program product for enabling a computer to perform a method according to the invention.

The above and other aspects of the invention will be apparent from and further elucidated with reference to the embodiments described hereafter, in which description reference will be made to the following figures, in which:

FIG. 1 is a block diagram of a system for use of a first preferred embodiment according to the present invention;

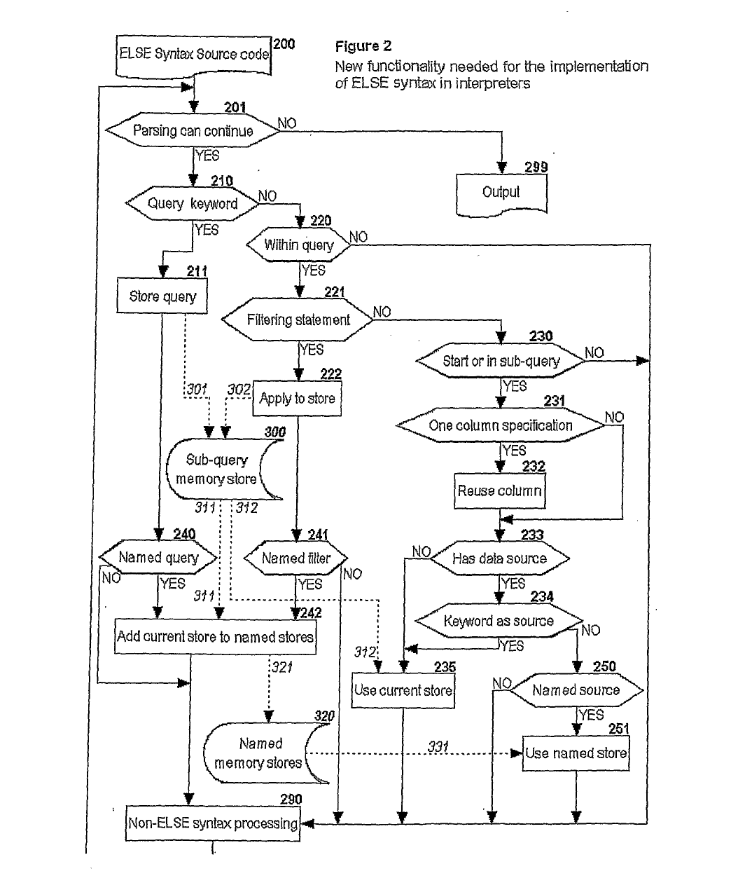

FIG. 2 is a block diagram depicting aspects included in a first preferred embodiment according to the present invention;

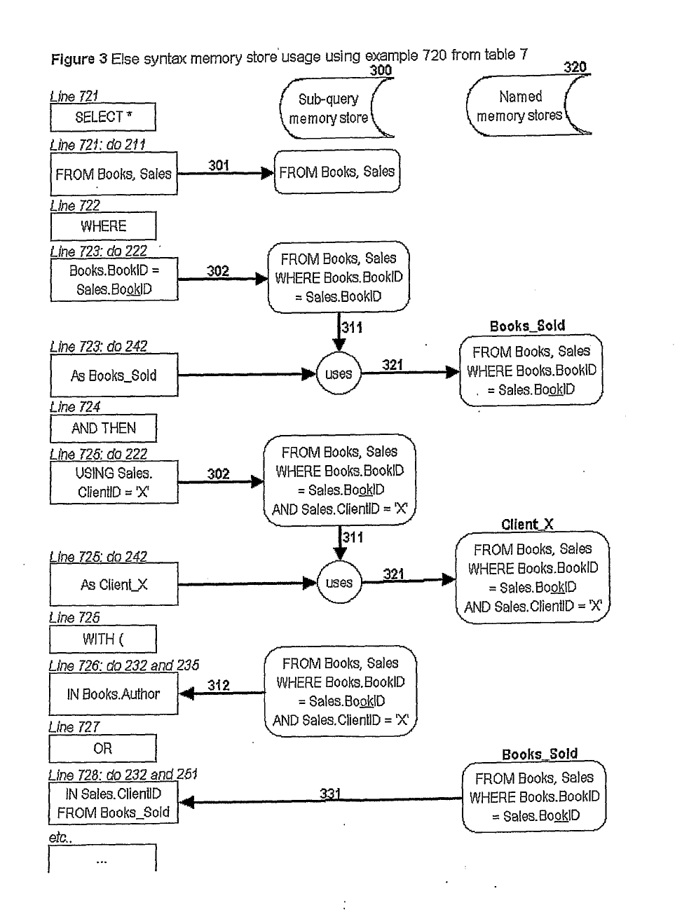

FIG. 3 is a block diagram of memory usage according to a preferred embodiment according to the present invention.

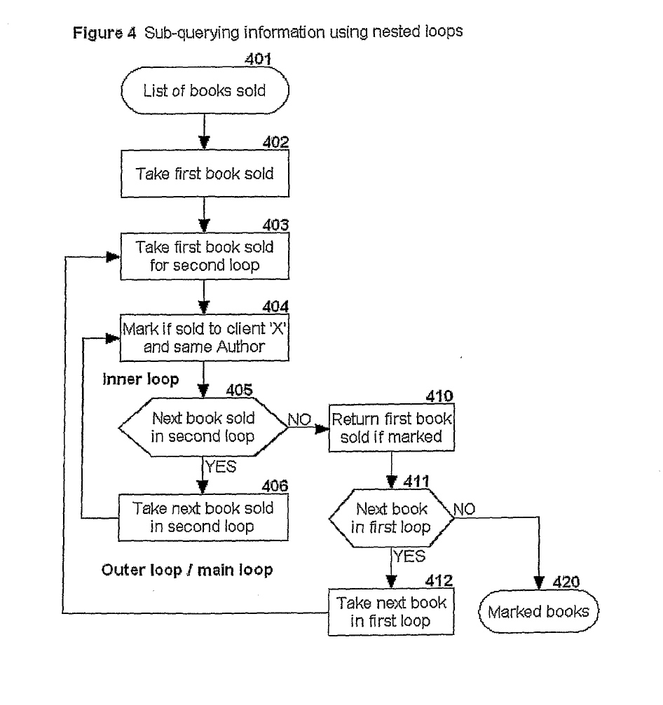

FIG. 4 is a block diagram further providing exemplary explanations of the present invention;

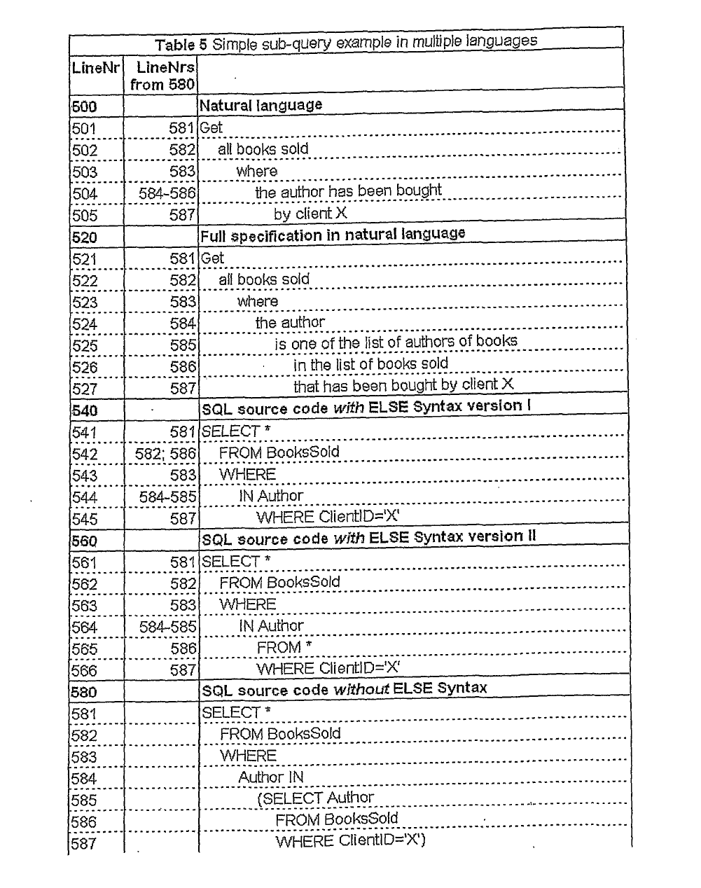

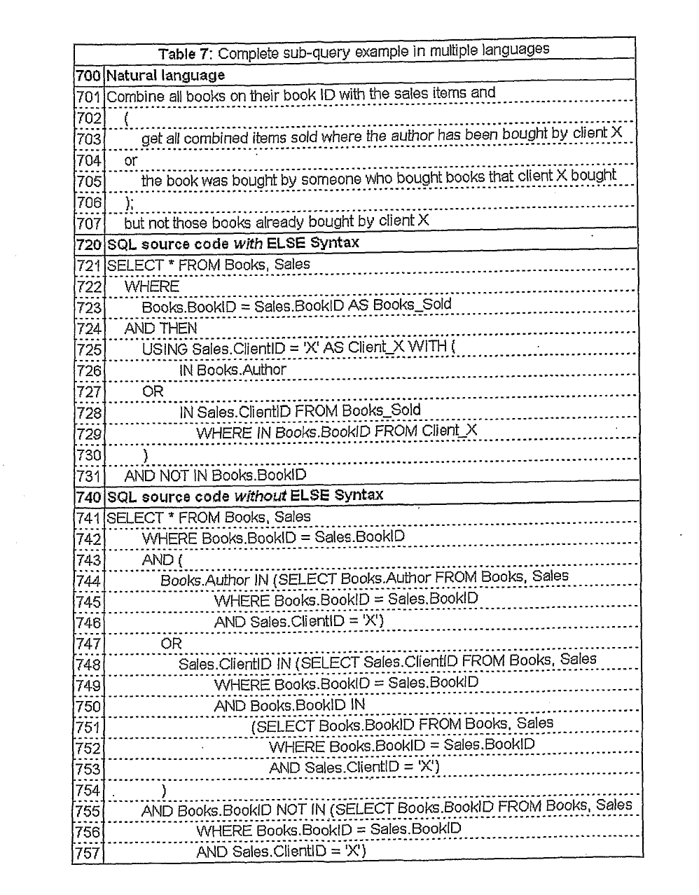

FIG. 5-7 are tables providing examples of the advantages of embodiments of the present invention.

In a first embodiment according to the present invention, memory stores are created to provide for a storage of data and/or query source data which are advantageously used for providing a resolution of a new programming syntax which provides for structure that is closer to the human understanding of language in forming e.g. queries. While using this embodiment, the amount of source code needed to specify a sub-query can be reduced relative to the state of the art when a data set of a sub-query is related to the data set of the main query within which it is used. According to this embodiment, such a main query data set definition is e.g. reused when the data set of the sub-query is equal to or a subset of the main query. It is therefore highly advantageous that while using the present invention, the syntax that is used while programming may be more in accordance with logic that can be applied in natural languages.

An example of a query using a sub-query is a bookstore that wants to advise client X what books to buy. One may ask: “Get all books sold where the author has been bought by client X”. “Has been bought” starts the sub-query and translates to the quantification: “their exists a book sold”. FIG. 4 illustrates the loop within a loop that performs this query. The outer loop (402, 411, 412) marks (410) the values that are part of the end result. The inner loop (403, 405, 406) is an example of a subquery that is used to confirm the existence of a piece of information (404).

One problem of the state of the art with subqueries—even with syntax level sub-query support—is the verbosity of the source code (102) written by programmers (101). I.e. the amount of information that the programmer has to specify for a sub-query. Example table 5 shows the example of FIG. 4 in both normal English (500) and as a full specification that contains all information needed in a programming language (520).

This example shows that in natural languages one can leave out a lot of information when linking information. Lines 524-526 can be stated much shorter as line 504 because speaker and listener share common knowledge to fill in the blanks and the listener can question points not clear in the original sentence. When writing a program an interpreter can only report an error (105). After writing the corrections (101) the programmer has to resubmit the whole source code (102) for reinterpretation (103).

The present invention provides for a novel way of technical workings of a computer that allows for a syntax that reduces the information needed for sub-query specification in programming languages. This method does not require the interpreter to have any “common” knowledge nor does it use data stored elsewhere. All needed information is available in the source code within the syntax that specifies the query.

In the following, this new form of syntax described in this patent is indicated as ELSE Syntax (which is intended as an acronym for Existence Logic with Simplified Syntax). The use of ELSE Syntax as defined by the present invention allows for a simplified sub-query syntax as query statements and other parts of the code may be used as the data source for sub-queries. Attention is to be drawn that the choice of actual phrases may look similar or even be identical to existing syntaxes of existing programming languages. This is however just a choice of syntax to stay close to the natural language meaning of such syntax (semantically), the logic that is applied being new and the technical way the computer operates being also new.

The query statement keywords may be familiar looping constructs like FOR and FROM or arbitrarily chosen new keywords. The sets of data may be arrays, lists, object collections, database records, XML items, etc. The filtering syntax may be familiar constructs like IF and WHERE. Interpreters in computer need new technical capabilities in order to be able to execute the logic behind the defined ELSE Syntax.

FIG. 2 illustrates the new functionality provided for in an interpreter according to an embodiment according to the present invention. In normal use, an interpreter functions to parse source code available in any computer language the interpreter is equipped for. An interpreter functions as long as no errors occur in the code and the process is not finished, i.e. the code is not ended yet. During parsing in step 201 of the source code 200 that is input for the process, the interpreter checks for query syntax keywords defined in the ELSE Syntax implementation. When these are found in step 210, the query created by the syntax has to be stored in a memory store in step 211 for reuse in later steps (236/246). This storage can be embodied in a memory store having any chose able form such as definable memory areas in ram, comprising e.g. tables, arrays, etc., here called the sub-query memory store 300. Optionally the ELSE Syntax implementation can provide for deciding whether the current state of the sub-query memory may be provided with a name in step 240. In case a name is provided, such a state is then stored in step 242 with the name in a named memory store 320. Next any non-ELSE syntax processing, that is of code according to the state of the art, continues in step 290.

In step 220 the interpreter checks whether it is processing within a query. If this is the case, the process continues in step 221, else the process continues in step 290. Within query statements the interpreter checks for filtering statements in step 221. This step is further disclosed below. Some of those statements will be used to filter in step 222 the items in the sub-query memory store 300. In step 241, it is determined whether naming is used and/or whether the filter is named, in which case in step 242 the state of the current store 300 is stored in the named memory store 320. Normal processing of the code can then continue in step 290.

To use these memory stores the interpreter performs checks in step 230 if sub-query syntax is present in queries of step 220. The sub-query may need to specify only one piece of data to link the query to the sub-query. In that case the data is reused on both the query and the sub-query in step 232. When the data items in the sub-query are linked to the same data items in the query and the query and sub-query data sources are the same, then data items may be specified only once. The query is then linked to the sub-query where the values of these data items are identical in both sources. In other words, the data items may be used as link items for both the main query and the sub-query.

Depending on a used implementation, the interpreter checks if there is no sub-query data-source specified in step 233 and/or the use of certain keywords in step 234, e.g. THIS or *, as the data source. In step 235 the current sub-query memory store 300 is used. A further way for reusing a store is when it is determined in step 250 that naming is implemented and a name is used as the query source for the sub-query. In that case the named instance 320 is used as the data source in step 251. After all these steps processing according to the state of the art continues in step 290.

Below, the method of FIG. 2 is described in greater detail. It is described in an exemplary way what architectural aspects are possibly envisaged for the implementation of ELSE Syntax in an interpreter. It is expressly stated that not all parts of FIG. 2 are required in order to start using ELSE Syntax.

The specific design of ELSE Syntax will different for each programming language. However, because the design aspects according to the invention is similar, the changes needed in interpreters are similar across all interpreters. It is the general design that is claimed in this patent. The specific design per language is insightful to the expert of each language in light of the disclosure of this document.

An embodiment of the ELSE Syntax according to this invention such as provided for SQL in the examples in tables 5, 6 and 7 (resp. FIG. 5-7) was chosen for ease of illustration only and is not the only way of implementing the invention.

The processing of non-ELSE Syntax code (290) is only shown as taking place after the processing of the ELSE Syntax for ease of illustration. In fact different parts of non-ELSE processing can occur at any moment in FIG. 2.

The Memory Stores

In this document, the wording “memory store” is used for both the sub-query memory store (300) and the named memory store (320). This generic wording is justifiable as the type of memory can be very different from implementation to implementation.

In many implementations the memory store will be a specific part of the memory of the interpreting program. Other implementations will use new data- or object-types to store the query syntax in a way that allows reuse. Such interpreters do not have their own memory store, but instead use one in the data-types and objects in the resulting program. Most programming languages need no new syntax to create data- and object-types, but new syntax is needed to use data- and object-types according to the present invention.

It is known in e.g. the LINQ project (Microsoft™) to implement queries using new object-types, but also creating new syntax to simplify the use thereof. The form and location of the memory store are not important when implementing syntax according to the present invention. What is important is that a new interpreter using some memory store is needed to interpret ELSE Syntax.

The Content of the Memory Stores

FIG. 3 illustrates in an exemplary way how the memory stores are used. The left column contains ELSE Syntax from the first 8 lines of example table 7. The numbered square boxes contain syntax from the given example lines and trigger the execution of the numbered “do” statements corresponding to boxes in FIG. 2. The arrows represent data exchanges to and from the memory stores. These data exchanges are also shown as dotted lines in FIG. 2.

FIG. 3 also shows the memory stores relative to executable code—opposed to the data that is queried. The reason for this is that what is stored and how may differ between implementations and even within implementations. Sometimes interpreters may re-execute the query code for the sub-query. At other times the same interpreter may use the cached result from the query for the sub-query or use concurrent processing of both queries.

ELSE Syntax may reuse parts of source code so that programmers need to specify those parts only once. From the point of view of the programmer the stores contain executable code. How an interpreter implements such reuse need not be an issue for the programmer.

Creating a Memory Store

In FIG. 2 the following steps are shown in relation to the bigger picture of FIG. 1, in which FIG. 2 may be comprised in step 103 of FIG. 1, FIG. 2 providing for an embodiment of interpreting the code:

Step 200: based on source code provided by a programmer in step 101, source code 102,200 (the input source 102 representing the input code 200) is provided comprising ELSE-Syntax. In this section the source code from table 5 is used as an example of such code.

Step 201: This source is parsed by an interpreter program as in step 103. As long as there is more source code and no errors have occurred according to step 104 the parsing can continue in step 201.

210: Certain syntax keywords are recognizable as query keywords of the ELSE Syntax. These can be existing keywords, such as FOR and FROM, but new keywords can be used as well. In example 540 line 541 (FIG. 5) does not contain these keywords in which case the interpreter continues to step 220, which is described below. Line 541 does contain the FROM keyword, based on which the interpreter continues in step 211.

Step 211 is described below as three distinct able action embodiments.

211a: The queries defined by the query keywords—BooksSold on line 542—are stored 301 in the sub-query memory store 300 for the scope defined by the query keyword.

211b: ELSE Syntax preferably adheres to normal scoping rules. A query specified by a FOR statement can be reused within the FOR statement. Functions called within this scope have their own scope and are therefore provided with their own sub-query store, unless the store is passed as a parameter. On the other hand, one can nest multiple FOR statements, since the scope of an inner loop is a combination of both it's own scope and the scope in which it is contained.

211c: SQL has a different scoping mechanism so each FROM statement signals the start of new sub-query store, i.e. within a nested query or a sub-query the sub-query memory store contains the contents of it's own FROM and not that of the containing query.

290: In this step processes according to the state of the art are performed on known syntax in addition to the non-ELSE processing the same query. Step 240 can also be triggered but is described later.

Using a Memory Store

The interpreter is parsing the code in step 201 and is not parsing a query statement (210 is false). In this section the example source from table 5 is used to illustrate the changes in the code enabled by ELSE-Syntax.

Step 220 is described below as two distinct able action embodiments.

220a: All other processing of ELSE-Syntax is done within query statements. This is true for all lines after line 542, so the interpreter will move to 221. Condition 221 will be described below, but if 221 fails the interpreter continues to 230. When the interpreted code is not within a query, normal processing continues (290).

220b: It is to be ascertained whether the interpreter is within a query, in which case the sub-query memory store (300) cannot be empty.

230: The memory store is used within the scope of the query of step 220 within sub-query statements. Line 543 of FIG. 5 does not contain a sub-query expression but line 544 does as it contains the keyword IN. So the interpreter continues in 231 on line 544. Where this not the case, normal processing may continue in step 290.

231: The first reuse occurs when only one column, field or other data item is specified in a sub-query statement. This is the case on line 544, so the interpreter continues in 232. Otherwise the interpreter continues in step 233.

232a: Without ELSE Syntax the query and sub-query are defined by different parts of the source code, therefore data items in both the main query and the sub-query must be stated to link them together. In ELSE Syntax both query and sub-query are defined by the same code. Therefore only one column needs to be specified if the query links to the sub-query on the same column. In example 540 line 544 replaces the lines 584 and 585 in example 580.

232b: This method does not need to access any memory store, but using the method without a single data source can create programming errors.

233: Next the interpreter checks if a data source is specified for the sub-query. When this is not the case, as on lines 544-545, the interpreter continues in step 235 and uses the sub-query memory store 300 as the data source for the sub-query. Otherwise the interpreter continues in step 234.

234: When specified in step 233 the data source can be a keyword that signals reusing the content of the memory store 300 as source for the sub-query. In example 560 line 565 the FROM * statement is an example of such a keyword usage and the interpreter continues in step 235 to reuse the content of the memory store. Otherwise the interpreter continues in step 250.

235: Both the occurrence in step 233 and step 234 signal the interpreter that it should retrieve 312 from memory store 300 the current contents of the memory store 300 and use it as the data source for the sub-query in step 235.

290: Having set this data source normal processing can continue.

Filtering the Memory Store

The methods described before in this detailed description form a preferred implementation of ELSE Syntax, although not the maximum achievable simplification of the source code. One more step is preferred allowing for a further simplified syntax. Programming languages contain filtering statements, e.g. IF statements or WHERE statements. These filters are often the same for the main query and sub-query data sources. ELSE-Syntax can allow programmers to reuse these filter statements.

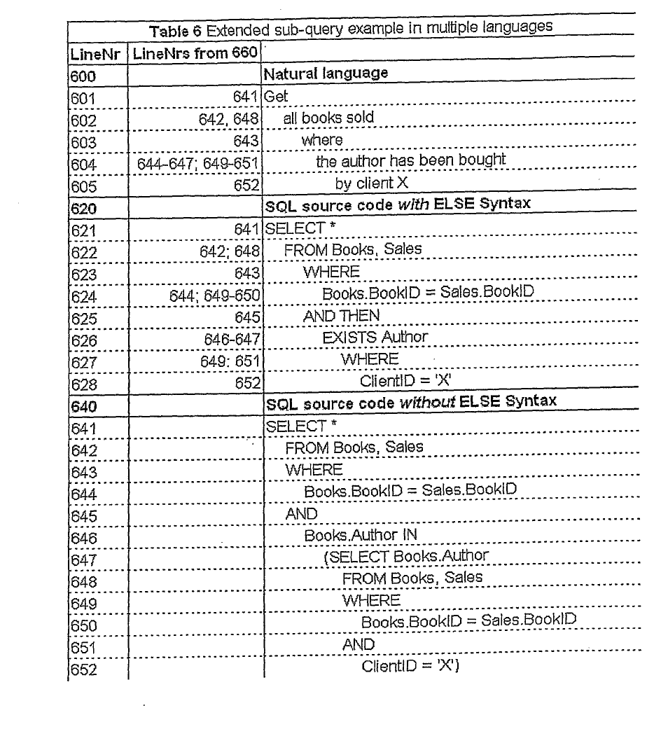

221a: Programming languages filter code execution using high level syntax statements like IF or WHERE. These statements should trigger filtering, but a further level of triggering is provided since these high level statements contain the sub-query statements. The example of table 6, FIG. 6, shows this in 640. Line 643 is a filter in accordance with step 221, and the sub-queries occur within the WHERE statement. Therefore a further triggering of filtering statements of step 221 is needed at the level of logical operators.

221b: Triggering at the level of operators means taking care of scope. In order to provide the simplification advantage for programmers, ELSE-Syntax preferably adheres to normal scoping rules; as described in relation to the step 211 for query storage. For line 644 to filter the sub-query data source to be used in the later lines, the AND of line 645 should keep line 644 in scope. As this may or may not be expected behavior in a programming language an option is to define new operators. Example 620 line 625 uses a new AND THEN operator/statement to indicate that lines 626, 627 and 628 are in the scope of line 624.

221c: The question whether to redefine existing operators or to create new ones is mainly one of taste and habit. As older code does not reuse the sub-query memory store, it may not effected by either choice. In cases where one wants to filter the main query but not the sub-query it is usually possible to state the reused part of the filter and the sub-query before the other filters; so only the main query is effected by these later filters. The case for Graphical User Interface based query tools is simpler. Using memory store filtering logical operators as the standard logical operators makes it easy to use sub-queries. Query tools may not facilitate the more complex capabilities of query languages as these are harder to display. ELSE Syntax makes the syntax of sub-queries simpler and therefore the graphical representation as well.

221d: Another possibility for intercepted filtering statements is to design syntax that effects only the sub-query memory store and not the main data source. Example table 7 shows the filter statement ClientID=‘X’ occurring in the sub-queries of example 740 in lines 746, 753 and 757; but only once with the ELSE Syntax version in example 720, line 725.

221e: In cases when filtering is triggered (221 is true) the interpreter continues in step 222, otherwise in step 230.

222: Filtering statements may contain code to be added to the sub-query memory store 300. In example 620 this is indicated in line 624. As the store contains the statement of line 622 the new content stored 302 is indicated in the lines 622 and 624. (For illustration: up to—line 723: do 222—FIG. 3 shows the process when parsing example 620 up to line 624, as well as example 720.)

290: Having filtered the data source, normal processing can continue (241 is described below).

The combination of memory store creation, usage and filtering is a preferred implementation of ELSE Syntax. Even when only some of the memory store filtering statements described here have been implemented, the result will be a significant simplification and shortening of the source code.

Naming New Stores

In more complex queries, an example of which is disclosed in example table 7, the repeated code can occur within statements having a different scope. A reason for this is that each FROM creates it's own scope. According to this embodiment, the ELSE Syntax method for achieving this is to allow assigning names to the sub-query memory store.

240: In case the current state of the sub-query memory store changes, a name may be attached to that state. So after a query is added to the store in step 211 a name may be attached to the new state and the interpreter continues in step 242. This does not occur in example 720. Normal processing continues in step 290.

241: Another embodiment for assigning a name is after a filtering statement changes the current store in step 222 through high level syntax or at the operator level or for the sub-query memory store. Lines 723 shows such an assignment at the operator level (using e.g. AS). Line 725 shows a name for a sub-query memory store only filtering statement. The interpreter continues in step 242, or otherwise in step 290.

242: When a name is added the interpreter fetches the current store 311 and stores it into a new store 321 with it's name in the named memory store 320. FIG. 3 shows the two examples of this process using lines 723 and 725 from example table 7.

290: After naming the normal processing according to the state of the art continues.

250a: Using the named memory store 320 is performed within query statements in step 220, outside filtering statements in step 221, in sub-queries of step 230 that have a data source of step 233 that is not a reuse keyword of step 234. When the data source is a name in the named memory store of step 250 the interpreter continues in step 251, otherwise in step 290. (FIG. 2 does not show this as access to the memory store, since the check for this name can be done in many ways)

250b: Scoping rules dictate that it is either not allowed to use any existing name for a named memory store or the named memory store takes precedence over existing names.

251: If a named memory store 320 is used it is retrieved 331 and used as the sub-query data source. FIG. 3 illustrates how line 728 in example 720 triggers the retrieval of a named memory store 331 that is clearly different from the current sub-query store that was retrieved at line 726.

290: After applying the named memory store 320 the normal processing continues.

An ELSE Syntax form without naming is sufficient for simplifying the specification of most sub-queries. It is also possible to create a syntax form that allows ELSE Syntax naming but does not allow data source reuse through keywords as in step 234 and sub-queries without query as in step 233. As this method would still have to create as in step 211 and filter as in step 222 a current sub-query memory store 300 such an embodiment is comprised in the ELSE Syntax implementation according to the invention.

Optimizing Execution Speed

One reason why sub-queries are sometimes avoided is execution speed. Since sub-queries are nested loops within nested loops they can increase execution times by multiple orders of magnitude. ELSE Syntax does not by definition decrease the execution time of programs written in it. However, the use of ELSE Syntax provides for a simplified signalling of reuse of code. This makes it easy for interpreters to optimize the execution of that code.

Traditional optimization has to search for instances of code reuse by comparing different pieces of code to each other. ELSE Syntax gives interpreters information for speed optimization by making code reuse explicit. The methods of ELSE Syntax state explicitly that “here is some filtered data set that may be reused” and “reuse that bit of code here”. In normal code this reuse would be implicit, i.e. it has to be noticed that “these pieces of code here and here are the same and they work on the same data set”. This is a quite difficult process.

Since code reuse is made explicit in the ELSE Syntax that is made possible by the present invention, many common optimizing strategies are easily implemented. Common sub expression elimination is easy when the interpreter knows that the code is the same. The same is valid for deciding to use result caching. One can combine the sub-query loops and the main loop for performing a first filtering, store the results into a cache and then create nested loops on the smaller cached result sets, a combination of loop nest optimization and loop splitting. Alternatively one can combine the sub-query loops and the main loop into one loop with small caches using a combination loop fusion and loop nest optimization. Column to column specification points to both loop fission and loop splitting. The number of times that some part of the code is being reused is important information for generating query execution plans and register allocation. Lastly the fact that the analyzed code itself is shorter simplifies the very process op optimization. ELSE Syntax thus enables simplification of optimization.

The present invention is not restricted to the described embodiments. Features from one described embodiment may be applied in other embodiments. The requested rights are defined in the annexed claims.

1. A method for creating a memory store for enabling a computer to interpret query programming code in which code reuse is defined, the method comprising steps for defining data sources for first-order quantified queries, also known as sub-queries, in which method the main query data sources can be used as the sub-query data source for any repeated execution of code over collections of data and combinations of collections of data, such as tables, arrays and object collections.

2. The method according to claim 1 comprising steps for specifying a link between main query and sub-query using a single data item when the sub-query data source reuses the main query data source.

3. The method according to claim 1 comprising steps for reusing the main query data source in sub-queries of the main query allowing for the sub queries to have no specified data source.

4. The method according to claim 1 comprising steps for reusing the main query data source in sub-queries of the main query allowing for new syntax keywords in sub-query statements.

5. The method according to claim 1 comprising steps for reusing syntax statements for filtering the main query data source for filtering the sub-query data source.

6. The method according to claim 5 comprising steps for defining logical operators with scopes that enable them to filter both the main query data source and the sub-query data source for other parts of the statements.

7. The method according to claim 5 comprising steps for defining syntax statements that filters only the sub-query data source for other parts of the statements

8. The method according to claim 1 comprising steps for providing a name for the current main query data source after queries have been added.

9. The method according to claim 1 comprising steps for naming the current main query data source after filters have been added.

10. The method according to claim 8 comprising steps for using named data sources as sub-query data source.

11. A computer equipped for performing the method according to claim 1.

12. A computer program product for when loaded on a computer system allowing a computer system to perform the method according to claim 1.

13. A data carrier comprising a computer program product for enabling a computer to perform the method according to claim 1.

14. A server computer comprising and/or equipped for distributing a computer program product for enabling a computer to perform the method according to claim 1.

15. A method for electronically or optically distributing a computer program product for enabling a computer to perform the method according to claim 1, the method comprising steps aimed at transfer of the computer program product.

16. A method for providing computer executing services by means of a computer program product for enabling a computer to perform the method according to claim 1.
